(19) United States
(12) Patent Application Publication
(10) Pub. No.: US 2026/0339263 A1
(43) Pub. Date: Oct. 29, 2026

(54) IMAGE FORMING APPARATUS

(71) Applicant: CANON KABUSHIKI KAISHA, Tokyo (JP)

(72) Inventors: KEITARO NAKATA, Shizuoka (JP); HIROKI EGUCHI, Kanagawa (JP); KODAI HAYASHI, Shizuoka (JP)

(21) Appl. No.: 19/650,115

(22) Filed: Apr. 16, 2026

(30) Foreign Application Priority Data
Apr. 28, 2025 (JP) 2025-074590
Oct. 1, 2025 (JP) 2025-165228

(51) Int. Cl. G03G 21/14; G03G 15/00; G03G 15/20; G03G 21/00

(52) U.S. Cl. CPC G03G 21/14; G03G 15/2039; G03G 15/2064; G03G 15/5004; G03G 15/657; G03G 21/0011; G03G 2215/00409; G03G 2215/00413; G03G 2221/0042

(57) ABSTRACT

An image forming apparatus has a second toner amount that is larger than a first toner amount, the first toner amount being a toner amount to be supplied, in a case where an ON signal is output from a loop detection sensor during execution of a first print job, to a photosensitive drum at a post-rotation time after completion of a first print job, the second toner amount being a toner amount to be supplied, in a case where the ON signal is not output from the loop detection sensor during execution of a second print job, to the photosensitive drum at the post-rotation time after completion of the second print job.

### BACKGROUND

### Field of the Technology

The present disclosure relates to an image forming apparatus and a process cartridge attachable to and detachable from the image forming apparatus.

### Description of the Related Art

The image forming apparatus forms an image on a recording material by using an electrophotographic image forming method. Examples of image forming apparatuses include copiers, printers (laser-beam printers, light emitting diode (LED) printers, and the like), facsimile apparatuses, word processors, and multifunction peripherals (multifunction printers) integrating these apparatuses.

Processes of a common image forming apparatus are known to be configured as follows. First, a surface of an image carrier for carrying an image, such as a photosensitive drum, is charged by a charging device. Then, an electrostatic latent image is formed on the surface of the image carrier by an exposure device. The electrostatic latent image is visualized into a toner image by a development device. Further, the toner image is transferred onto a recording material, such as paper, by a transfer device including a transfer roller. The recording material on which the toner image has been transferred is sent to a fixing unit. While the toner image is fixed by the fixing unit, toner remaining on the image carrier is removed by a cleaning device.

A fixing unit including a pressure roller that pinches and conveys a recording material is known. When the pressure roller thermally expands due to a sheet passing condition or the like, a conveyance speed of the recording material changes. A portion at which the recording material is pinched and conveyed while a toner image is being transferred to the recording material by the transfer device is referred to as a transfer nip portion. A portion at which the recording material is pinched and conveyed while the toner image is being fixed to the recording material by the fixing unit is referred to as a fixing nip portion. In this configuration, as viewed in a rotational axis direction of the photosensitive drum, a direction in which rotational axes of the photosensitive drum and the transfer roller are connected is defined. A case with a configuration in which the fixing nip portion is disposed on an image carrier side with respect to the transfer nip portion in the direction is described. Further, the configuration has timing at which the recording material is simultaneously pinched and conveyed by both the fixing nip portion and the transfer nip portion. In an image forming apparatus having such a configuration, a degree of winding of the recording material around the image carrier may change on a downstream side of the transfer nip portion in a conveyance direction of the recording material.

If the recording material warps to wind around the image carrier on the downstream side of the transfer nip portion, a sufficient discharge gap cannot be obtained between the recording material and the image carrier, resulting in a reduced discharge amount. Consequently, a surface potential of the image carrier is maintained high. If the surface potential of the image carrier after a transfer process is high, an image force of adherends, such as paper dust, adhering to the surface of the image carrier becomes strong when the recording material is conveyed. If paper dust is conveyed to a contact portion between the photosensitive drum and a cleaning blade under a condition in which the image force is strong, foreign substances, such as fibrous paper dust, may be caught at a leading edge of the cleaning blade. Alternatively, foreign substances, such as particulate paper dust, may intrude into the leading edge of the cleaning blade. This may change friction with the photosensitive drum at a portion of the cleaning blade. A decrease in cleaning performance due to such a friction change may cause a cleaning failure.

Japanese Patent Laid-Open No. 63-172295 describes a configuration in which, when an image forming period is defined as a period during which an image to be transferred onto a recording material is formed, an operation is performed to supply toner to a contact portion between an image carrier and a cleaning blade during a non-image forming period. Japanese Patent Laid-Open No. 63-172295 describes a technique of removing paper dust accumulated between the image carrier and the cleaning blade and allowing the supplied toner to function as a lubricant, which maintains a stable cleaning state.

### SUMMARY

According to an aspect of the present disclosure, an image forming apparatus includes a photosensitive drum configured to carry a toner image, a development unit configured to supply toner to a surface of the photosensitive drum to develop the toner image, a transfer roller configured to come into contact with the photosensitive drum to form a transfer nip portion for transferring the toner image onto a recording material, and convey the recording material, a cleaning blade configured to come into contact with the photosensitive drum and, after the toner image is transferred onto the recording material, clean the surface of the photosensitive drum, a heating unit configured to heat the toner image transferred onto the recording material, a pressure roller configured to come into pressure contact with the heating unit to form a fixing nip portion, and pinch and convey the recording material, and a loop detection sensor configured to output an ON signal when a loop amount is larger than a predetermined value, the loop amount being a size of a warp of the recording material formed in a state where both the transfer nip portion and the fixing nip portion pinch and convey the recording material, wherein a second toner amount is larger than a first toner amount, the first toner amount being a toner amount to be supplied, in a case where the ON signal is output from the loop detection sensor during execution of a first print job, to the photosensitive drum at a post-rotation time after completion of the first print job, the second toner amount being a toner amount to be supplied, in a case where the ON signal is not output from the loop detection sensor during execution of a second print job, to the photosensitive drum at the post-rotation time after completion of the second print job.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating an overall configuration of an image forming apparatus according to a first embodiment.

FIG. 2 is a schematic cross-sectional view illustrating an overall configuration of a fixing apparatus according to the first embodiment.

FIG. 3 is a schematic cross-sectional view illustrating an overall configuration of a process cartridge according to the first embodiment.

FIG. 4 is a block diagram illustrating a configuration of the image forming apparatus according to the first embodiment.

FIG. 5 is an enlarged cross-sectional view illustrating a configuration of a contact portion between a cleaning blade and a photosensitive drum.

FIGS. 6A and 6B are schematic views illustrating a conveyance behavior in a state where a recording material is warped.

FIGS. 7A and 7B are schematic views illustrating a conveyance behavior in a state where a recording material is tensed.

FIG. 8 is a diagram illustrating a transition of a surface potential of a photosensitive drum on a downstream side of a transfer nip portion.

FIG. 9 is a graph illustrating a relationship between a speed of a pressure roller and a temperature of the pressure roller.

FIG. 10 is a graph illustrating a relationship between a temperature of the pressure roller and a fixing count.

FIG. 11 is a flowchart illustrating a toner purge sequence according to the first embodiment.

FIG. 12 is a schematic cross-sectional view illustrating an overall configuration of an image forming apparatus according to a second embodiment.

FIG. 13 is a flowchart illustrating a toner purge sequence according to the second embodiment.

### DESCRIPTION OF THE EMBODIMENTS

### First Embodiment

Hereinafter, modes for carrying out the present disclosure will be exemplarily described with reference to the drawings.

### (Configuration of Image Forming Apparatus)

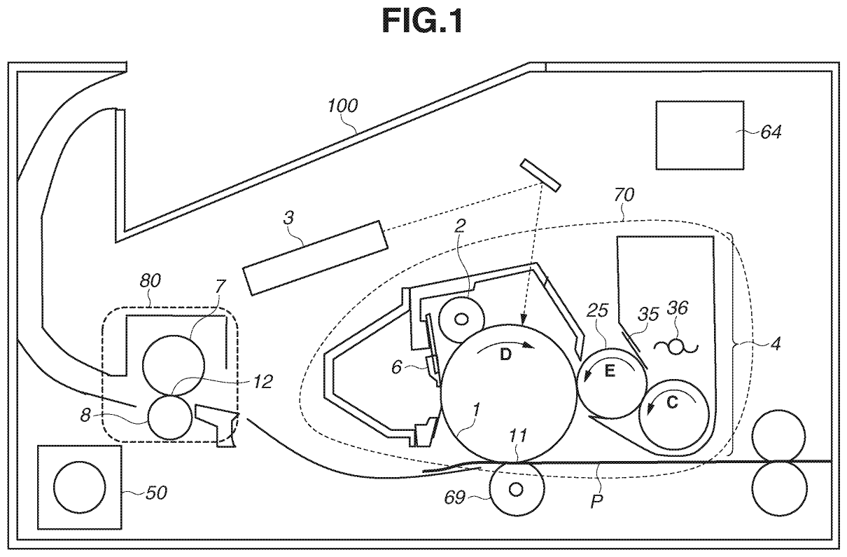

FIG. 1 is a schematic cross-sectional view illustrating an image forming apparatus 100 according to a first embodiment. First, an overall configuration of the image forming apparatus 100 will be described below. As illustrated in FIG. 1, a process cartridge 70 attachable to and detachable from the image forming apparatus 100 is attached to the image forming apparatus 100 by an attaching member (not illustrated). A scanner unit 3 for forming a latent image on a photosensitive drum 1 serving as an image carrier is disposed above the process cartridge 70. The photosensitive drum 1 is rotatably attached to the process cartridge 70. The scanner unit 3 selectively exposes the photosensitive drum 1 to light. Thus, an electrostatic latent image is formed on the photosensitive drum 1. The electrostatic latent image is developed by a developing roller 25.

With this operation, a toner image is formed on the photosensitive drum 1. A registration roller pair (not illustrated) conveys a recording material P in synchronization with the image forming operation. The recording material P is conveyed to a transfer nip portion 11 at which the photosensitive drum 1 and a transfer roller 69 are in contact with each other. A transfer bias voltage is applied from a power source to the transfer roller 69. Thus, the toner image on the photosensitive drum 1 is transferred onto the recording material P. An image is formed on the recording material P in this way. The recording material P on which the image has been formed is heated and pressurized by a fixing apparatus 80. Through this process, the toner image is fixed to the recording material P.

Thereafter, the recording material P is discharged out of the image forming apparatus 100 by a discharge roller. All the above-described members are driven only by a main motor 50.

### (Configuration of Fixing Apparatus)

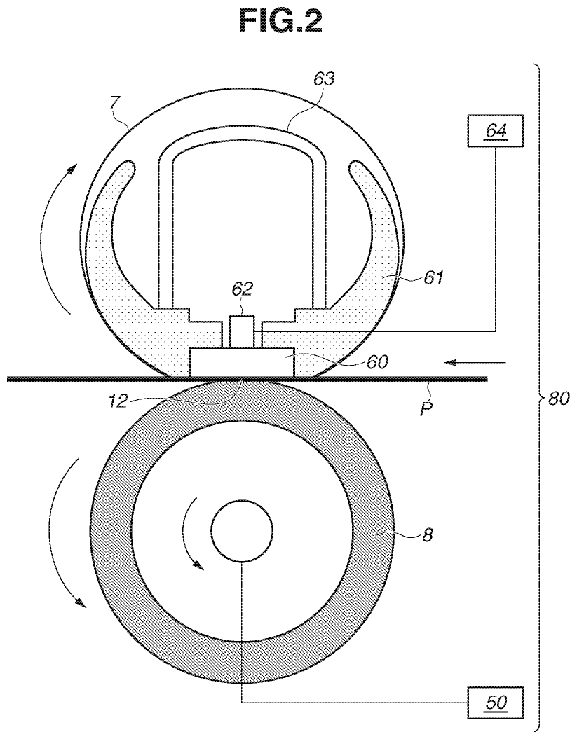

A configuration of the fixing apparatus 80 will be described below. FIG. 2 is a schematic cross-sectional view illustrating a configuration of the fixing apparatus 80 according to the present embodiment. The fixing apparatus 80 includes a fixing film 7, a pressure roller 8 in contact with an outer circumferential surface of the fixing film 7, and a heater 60. The heater 60 is a heating member disposed in an inner space of the fixing film 7.

The fixing film 7, the pressure roller 8, and the heater 60 extend in a rotational axis direction of the pressure roller 8 that perpendicularly intersects a conveyance direction of the recording material P.

The fixing film 7 is a high heat-resistant member having a multilayer structure and is formed in a cylindrical form. The fixing film 7 includes a base layer and a release layer. The base layer is made of a heat-resistant resin, such as polyimide, and is formed with a thickness of 100 μm or less. The release layer is a layer coated with a resin and serves as a surface layer of the fixing film 7. As the resin, a fluorine resin having excellent releasability, such as perfluoroalkoxy alkane (PFA), is used.

The pressure roller 8 includes a core metal and an elastic layer. The core metal is made of iron, aluminum, or the like. The elastic layer is made of a heat-resistant rubber material, such as silicone rubber. In the present embodiment, the core metal is an aluminum core metal, and the elastic layer includes a base layer made of silicone rubber. PFA is used for a surface layer covering the base layer of the elastic layer. As an external form, the pressure roller 8 is about 30 mm in diameter, and the elastic layer is about 4 mm in thickness.

The heater 60 is a ceramic heater. A heat generating element made of silver paste or the like is applied, by screen printing or the like, to an alumina ceramic substrate or the like serving as a base material. A glass coat is formed on the heat generating element as an insulation protective layer. The glass coat of the heater 60 comes into contact with an inner surface of the fixing film 7.

The heater 60 is held by a heater holding member 61. The heater holding member 61 holding the heater 60 is held by a metal stay member 63. A pressing force is applied to the pressure roller 8 by a pressing mechanism (not illustrated). The pressure roller 8 is brought into pressure contact with the heater 60 via the fixing film 7. Accordingly, a fixing nip portion 12 at which the recording material P is pinched and conveyed is formed. That is, the heater 60, as a heating member, heats the fixing film 7. Further, the heater 60, as a nip forming member, forms the fixing nip portion 12 together with the pressure roller 8.

The core metal of the pressure roller 8 is configured to receive a driving force from the main motor 50 via a coupling gear or the like. When the pressure roller 8 is rotatably driven by the main motor 50, the fixing film 7 is driven to rotate accordingly. When the recording material P is pinched and conveyed while being heated at the fixing nip portion 12, an unfixed toner image on the recording material P is pressurized and fixed.

A thermistor 62 serving as a temperature detection element is disposed in contact with the heater 60. In the present embodiment, the thermistor 62 is in contact with a longitudinal center portion of the heater 60. A longitudinal direction of the heater 60 matches the rotational axis direction of the pressure roller 8.

As illustrated in FIG. 1, the image forming apparatus 100 includes a control unit 64 that performs various types of control.

The control unit 64 controls power supply to the heater 60 in the fixing apparatus 80 in FIG. 2. The control unit 64 controls power supply based on a result of temperature detection by the thermistor 62 in such a manner that a temperature detected by the thermistor 62 becomes a desired target temperature. The control unit 64 controls the image forming apparatus 100 to cause image formation and a fixing operation to be performed under image forming conditions and at a fixing temperature according to a print mode set by a user. (Configuration of Process Cartridge)

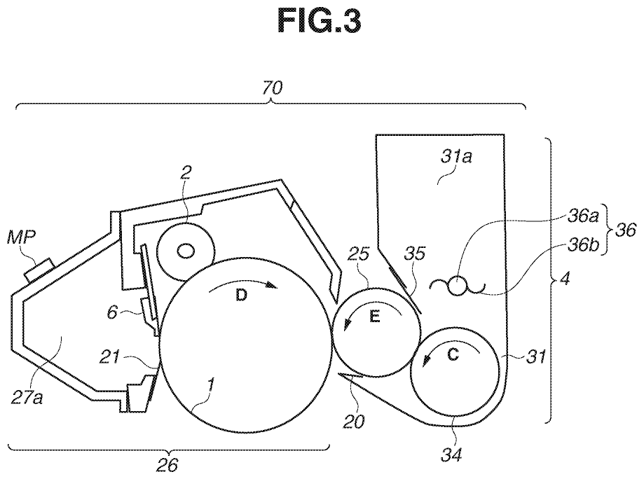

A configuration of the process cartridge 70 will be described below. FIG. 3 is a schematic cross-sectional view illustrating the process cartridge 70 according to the present embodiment. As illustrated in FIG. 3, the process cartridge 70 includes a cleaning apparatus 26 and a development apparatus 4.

The cleaning apparatus 26 includes the photosensitive drum 1, a charging roller 2, and a cleaning blade 6. The charging roller 2 and the cleaning blade 6 are disposed on an outer circumference of the photosensitive drum 1. The cleaning blade 6 includes an elastic member formed of a rubber blade and a cleaning support member. A leading edge portion of the rubber blade is disposed to be in contact with the photosensitive drum 1 in a counter direction with respect to a rotational direction indicated by an arrow D. The leading edge portion of the rubber blade removes residual toner on a surface of the photosensitive drum 1 to clean the surface of the photosensitive drum 1. The residual toner removed from the surface of the photosensitive drum 1 by the cleaning blade 6 drops into a removed toner chamber 27a. To prevent leakage of removed toner from the removed toner chamber 27a, a squeeze sheet 21 is in contact with the photosensitive drum 1. A driving force from a main body drive motor (not illustrated) serving as a driving source is transmitted to the cleaning apparatus 26. With this driving force, the photosensitive drum 1 is rotatably driven in the direction indicated by the arrow D in accordance with an image forming operation. The charging roller 2 is rotatably attached to the cleaning apparatus 26. The charging roller 2 is pressurized toward the photosensitive drum 1 by a charging roller pressure member (not illustrated). With this operation, the charging roller 2 is driven to rotate accordingly by the photosensitive drum 1.

The development apparatus 4 includes the developing roller 25, a development frame 31, a toner supply roller 34, and a development blade 35. The developing roller 25 rotates in a direction indicated by an arrow E while being in contact with the photosensitive drum 1. The development frame 31 supports the developing roller 25. The toner supply roller 34 is disposed on a circumference of the developing roller 25 and rotates in a direction indicated by an arrow C while being in contact with the developing roller 25. The development blade 35 is disposed to regulate a toner layer on the developing roller 25.

Toner is supplied from the toner supply roller 34 to the developing roller 25. Then, the toner passes by the development blade 35. In this operation, the development blade 35 regulates an amount of toner coating on the developing roller 25, and the toner is charged. This forms a toner coat most suitable for developing a latent image formed on the photosensitive drum 1. The developing roller 25 and the photosensitive drum 1 rotate while being in contact with each other at a facing portion (contact portion). At the facing portion (contact portion), surfaces of the developing roller 25 and the photosensitive drum 1 move in the same direction (a downward direction in the present embodiment). A predetermined direct current (DC) bias is applied to the developing roller 25. According to the present embodiment, the toner is negatively charged by triboelectric charging. Due to a potential difference, the toner is transferred only to light-area potential portions, and the electrostatic latent image is visualized.

A blowout prevention sheet 20 is disposed in the development apparatus 4. The blowout prevention sheet 20 is a development contact sheet for preventing toner leakage from a gap between the developing roller 25 and the development frame 31.

Further, a toner conveyance member 36 is disposed in a toner storage chamber 31a of the development frame 31.

The toner conveyance member 36 is provided to stir stored toner and convey the toner to the toner supply roller 34. The toner conveyance member 36 includes a stirring shaft 36a and a sheet member 36b. The stirring shaft 36a is rotatable by a driving force from outside. The sheet member 36b is attached to the stirring shaft 36a and rotates together with the stirring shaft 36a.

### (Storage Unit of Process Cartridge)

As illustrated in FIG. 3, the process cartridge 70 (hereinafter simply referred to as a cartridge) further includes a storage medium memory MP (memory MP). The memory MP is a nonvolatile storage unit. Usage information and life information regarding the cartridge 70 are stored in the memory MP. A usage status and a replacement time (life) of the development apparatus 4 are calculated based on the information. Even when power of a main body of the image forming apparatus 100 is turned ON or OFF or when the cartridge 70 is replaced, the calculation is performed accurately and rapidly. (Block Diagram Illustrating Image Forming Apparatus)

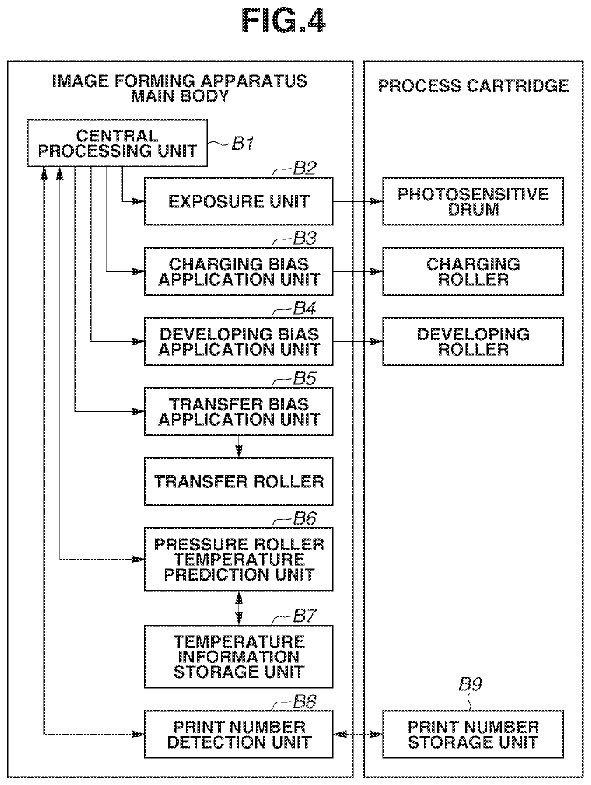

An image forming operation of the image forming apparatus 100 according to the first embodiment will be described below with reference to FIG. 4. FIG. 4 is a block diagram illustrating a configuration of the image forming apparatus 100 according to the first embodiment.

As illustrated in FIG. 4, the main body of the image forming apparatus 100 includes a central processing unit B1, an exposure unit B2, a charge bias application unit B3, a developing bias application unit B4, and a transfer bias application unit B5. The main body of the image forming apparatus 100 further includes a pressure roller temperature prediction unit B6, a temperature information storage unit B7 storing pressure roller temperature information, and a print number detection unit B8. The process cartridge 70 detachably attached to the main body of the image forming apparatus 100 includes a print number storage unit B9 storing print number information.

First, the charge bias application unit B3 applies a voltage to the charging roller 2 based on an instruction from the central processing unit B1 included in the main body of the image forming apparatus 100. Thus, the photosensitive drum 1 is uniformly charged. Then, the photosensitive drum 1 is irradiated with a laser beam by the scanner unit 3 serving as the exposure unit B2. Thus, an electrostatic latent image is formed on the photosensitive drum 1. Then, the developing bias application unit B4 applies a voltage to the developing roller 25. Thus, toner is supplied onto the photosensitive drum 1. Then, the electrostatic latent image on the photosensitive drum 1 is developed and visualized as a developer image. The toner image as the developer image is transferred onto a recording material. The transfer is performed when the transfer bias application unit B5 applies a voltage to the transfer roller 69.

As described above, the toner image on the photosensitive drum 1 is transferred onto a recording material, such as paper, via the transfer roller 69. In this operation, a residual transfer substance, such as developer that has not been transferred, may remain on the photosensitive drum 1. In the image forming apparatus 100 in the first embodiment, the residual transfer substance is removed by the cleaning blade 6.

### (Lubrication Layer in Cleaning)

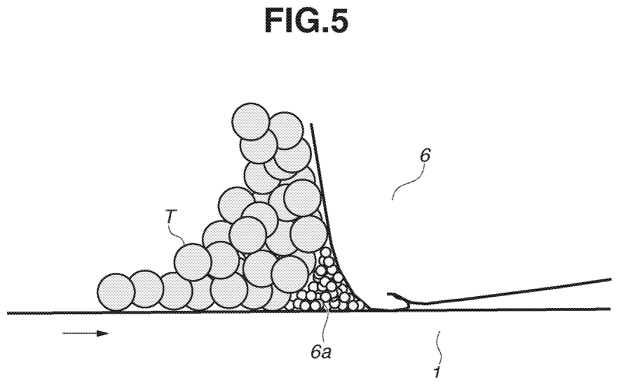

FIG. 5 is an enlarged cross-sectional view illustrating the contact portion at which the cleaning blade 6 and the photosensitive drum 1 come into contact with each other. An external additive (additive particles), such as silica, is present on a surface of toner (T) contained in the residual transfer substance. The external additive (additive particles), such as silica, transfers to the photosensitive drum 1, and the transferred external additive forms a lubrication layer 6a. The lubrication layer 6a serves as a barrier layer at an edge portion of the cleaning blade 6. As illustrated in FIG. 5, the surface of the photosensitive drum 1 advances in a direction indicated by an arrow. A frictional force acting on the contact portion between the cleaning blade 6 and the photosensitive drum 1 is reduced by the lubrication layer 6a of toner. This suppresses curling and chipping of the cleaning blade 6, improving cleaning performance.

Meanwhile, part of the lubrication layer 6a gradually passes through the contact portion between the cleaning blade 6 and the photosensitive drum 1 due to a rotation operation of the photosensitive drum 1, or the lubrication layer 6a gradually decreases due to circulation of residual toner at the contact portion between the cleaning blade 6 and the photosensitive drum 1.

Consequently, the lubrication layer 6a is depleted in the following cases. For example, when images having a low printing ratio continue to be printed, the amount of toner contained in the residual transfer substance decreases. Then, if an amount of external additive supplied to the lubrication layer 6a falls below an amount of reduction of the external additive due to the above-described passage or the circulation of the residual toner, the lubrication layer 6a is depleted. The depletion of the lubrication layer 6a may cause curling and chipping of the cleaning blade 6. Therefore, maintaining the lubrication layer 6a at all times is important.

### (Toner Purge Sequence)

Methods for maintaining the lubrication layer 6a include a method referred to as a toner purge sequence.

The toner purge sequence is a series of operations that are performed during a non-image forming period.

When the toner purge sequence is started, a toner image is formed on the photosensitive drum 1 by an image forming process including the above-described charging, exposure, and development. The transfer roller 69 is applied with a bias that is closer to a surface potential of the photosensitive drum 1 than a bias at an image forming time. Thus, toner supplied from the developing roller 25 is supplied to the contact portion between the cleaning blade 6 and the photosensitive drum 1. The external additive present on the surface of the supplied toner transfers to the photosensitive drum 1 to re-form the lubrication layer 6a.

The non-image forming period refers to a period during which no recording material, such as paper, passes through the contact portion between the photosensitive drum 1 and the transfer roller 69. Specific examples of the non-image forming period include a multiple pre-rotation time, a pre-rotation time, a sheet interval process time, a post-rotation time, and a standby time. These times will be described in detail below.

The multiple pre-rotation time is an activation operation period (a starting operation period and a warm-up period) of the image forming apparatus 100. The multiple pre-rotation time refers to a period during which the main motor 50 is driven to rotatably drive the photosensitive drum 1 and the image forming apparatus 100 performs a predetermined preparation operation. The multiple pre-rotation operation is performed when the main body of the image forming apparatus 100 is supplied with power or when a door is opened or closed.

The pre-rotation time is an operation period during which a printing operation is performed, following the multiple pre-rotation time when a print signal is input during the multiple pre-rotation time. If no print signal is input, driving of the main motor 50 is temporarily stopped after completion of the multiple pre-rotation time.

Then, the rotational drive of the photosensitive drum 1 is stopped, and the image forming apparatus 100 is kept stopped until a next print signal is input. When the next print signal is input, the main motor 50 is driven again, the photosensitive drum 1 starts rotating, and a pre-rotation operation is performed.

The sheet interval process time refers to a period, in printing of a plurality of recording materials in succession, from when a trailing edge portion of a preceding recording material passes through the transfer roller 69 until a leading edge portion of the following recording material reaches the transfer roller 69. That is, the sheet interval process time refers to a non-sheet passing period of the recording material at the transfer roller 69 when the plurality of recording materials is printed in succession.

The post-rotation time refers to a period during which a predetermined post-rotation operation is performed. When printing on a last recording material is completed in a print job, the main motor 50 continues to drive to rotatably drive the photosensitive drum 1 for a certain period. This period is referred to as the post-rotation time.

The timing when printing on the last recording material is completed refers to timing after a trailing edge portion of the last recording material in the job passes through the transfer nip portion 11. In other words, the timing is timing at which the recording material is not in the transfer nip portion 11 and driving of the main motor 50 is not interrupted.

When the predetermined post-rotation is completed, driving of the main motor 50 is stopped, and rotational driving of the photosensitive drum 1 stops. A period from this timing until a next print start signal is input is referred to as the standby time.

A toner purge operation will be described below. When the main body of the image forming apparatus 100 receives a print command from outside, the print number detection unit B8 detects and acquires print number information from the print number storage unit B9. When the acquired print number exceeds a predetermined print number, toner is supplied. The timing of supplying toner is not limited to the post-rotation time and may be a sheet interval process time as long as the timing is in a non-image forming period.

For example, when a toner purge operation is performed between sheets, a transfer bias close to the surface potential of the photosensitive drum 1 is applied to the transfer roller 69 during a period from when a trailing edge of a first sheet passes through the transfer nip portion 11 until a leading edge of a second sheet reaches the transfer nip portion 11. Exposure and development are performed in this state, so that toner is supplied to the cleaning apparatus 26. In a case where the sheet interval is short relative to a desired purge amount, the sheet interval may be extended only at the purge timing. Such control is effective in a case where the lubrication layer 6a is depleted during continuous sheet passing when only post-rotation purge is performed.

The print number as a condition for performing a toner purge operation may be changed based on an environment and a usage history. As the condition for performing the toner purge operation, a usage rate of the photosensitive drum 1 calculated based on a rotation time and a charging time of the photosensitive drum 1 may be used. (Cleaning Performance Degradation Due to Paper Dust)

Causes of cleaning performance degradation include an effect of paper dust contained in the residual transfer substance. Paper dust refers to fibers and fillers dropped off from a recording material. Many pieces of paper dust have a size on the order of sub-millimeters. Components of paper dust include calcium carbonate, kaolin, talc, and titanium dioxide, which are brighteners for increasing whiteness of paper. In general, at shipment, paper dust and other foreign substances are removed through removal processing, such as air blowing. However, in the image forming apparatus 100, frictional force is applied to the recording material by conveyance rollers in a recording-material conveyance path. In the recording-material conveyance path for paper in the image forming apparatus 100, the recording material is repeatedly bent along shapes of the conveyance rollers a plurality of times. This breaks a bonding structure between paper fibers and fillers, and powdery fillers and fibers are more likely to drop off. Fibers and fillers dropped off in this way adhere to the photosensitive drum 1 that is in pressure contact with the recording material P at the transfer nip portion 11.

In particular, if paper dust reaches the contact portion between the cleaning blade 6 and the photosensitive drum 1 in a state where adhesion of the paper dust to the photosensitive drum 1 is strong, the paper dust may destroy the lubrication layer 6a and then be caught at the contact portion between the cleaning blade 6 and the photosensitive drum 1. If the paper dust is caught at the contact portion, the paper dust is pressed onto the photosensitive drum 1 by the cleaning blade 6. This may cause the paper dust to scrape the photosensitive drum 1. Further, the paper dust caught at the contact portion creates a gap between the cleaning blade 6 and the photosensitive drum 1, and allows toner to pass through the gap. Toner passing through the gap may cause a cleaning failure.

Methods for removing the paper dust include a method for increasing an amount of toner purge. However, since this method increases toner consumption during a non-image forming period, a printable sheet number decreases, which is problematic.

### (Change in Paper Dust Adhesion Due to Paper Tensile State)

In the present embodiment, adhesion of paper dust to the photosensitive drum 1 changes. The adhesion changes according to a tensile state of the recording material P in a positional relationship between the transfer nip portion 11 and the fixing nip portion 12. The tensile state of the recording material P varies by a difference between a conveyance speed of the recording material P at the transfer nip portion 11 and a conveyance speed of the recording material P at the fixing nip portion 12.

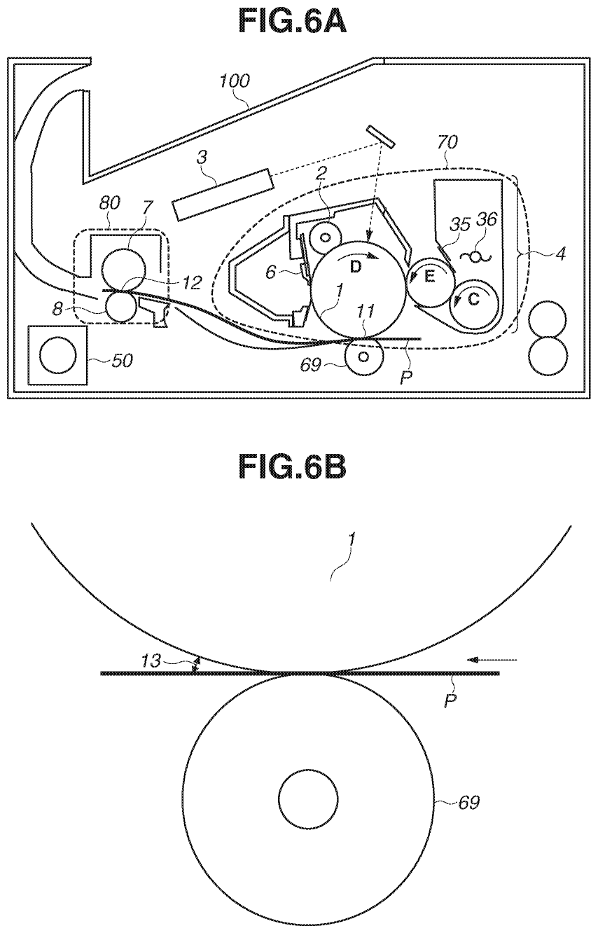

A mechanism in which the adhesion of paper dust to the photosensitive drum 1 changes according to the tensile state of the recording material P will be described below with reference to FIGS. 6A, 6B, and 5.

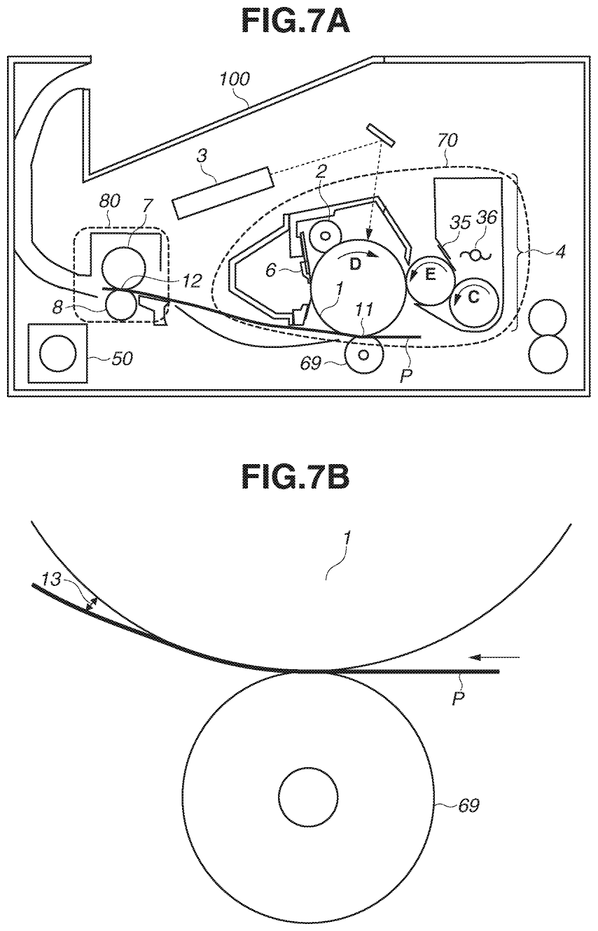

FIG. 6A illustrates a conveyance behavior of the recording material P. FIG. 6A illustrates the conveyance behavior in a case where the conveyance speed of the recording material P at the fixing nip portion 12 is equal to or lower than the conveyance speed of the recording material P at the transfer nip portion 11. In this case, the recording material P is pushed out by the transfer nip portion 11 by an amount larger than an amount by which the recording material P is pulled in by the fixing nip portion 12. Consequently, the recording material P bends (a loop amount increases, the loop amount at this time being referred to as a first loop amount). FIG. 6B is an enlarged view illustrating the transfer nip portion 11 at this time. Due to warp in the recording material P, a discharge gap 13 occurs between the recording material P and the photosensitive drum 1. The discharge gap 13 is a gap required for starting discharge. The discharge gap 13 occurs at a position closer to the transfer nip portion 11 in a conveyance direction of the recording material P than a position in a case of FIGS. 7A and 7B (a loop amount decreases, the loop amount at that time being referred to as a second loop amount). In a vicinity of the transfer nip portion 11, a distance between the photosensitive drum 1 and the transfer roller 69 is short. Thus, an electric field becomes strong, and a discharge amount between the recording material P and the photosensitive drum 1 increases. The increased discharge amount causes electric charge on a surface of the photosensitive drum 1 to move to the recording material P. This decreases the surface potential of the photosensitive drum 1.

FIG. 7A illustrates the conveyance behavior of the recording material P in a case where the conveyance speed of the recording material P at the fixing nip portion 12 is higher than the conveyance speed of the recording material P at the transfer nip portion 11. In this case, the recording material P is pulled in by the fixing nip portion 12 by an amount larger than an amount by which the recording material P is pushed out by the transfer nip portion 11. Consequently, the recording material P becomes tense (the loop amount decreases). FIG. 7B is an enlarged view illustrating the transfer nip portion 11 at this time. Due to the tension in the recording material P, the recording material P winds around the photosensitive drum 1 in the present embodiment. The discharge gap 13 between the recording material P and the photosensitive drum 1 occurs at a position farther from the transfer nip portion 11 in the conveyance direction of the recording material P than the position in the case of FIGS. 6A and 6B (the loop amount increases). At the position farther from the transfer nip portion 11, the electric field between the photosensitive drum 1 and the transfer roller 69 is weak. Thus, the discharge amount between the recording material P and the photosensitive drum 1 is small. The decreased discharge amount reduces the amount of electric charge on the surface of the photosensitive drum 1 moving to the recording material P. This maintains the surface potential of the photosensitive drum 1 to be high.

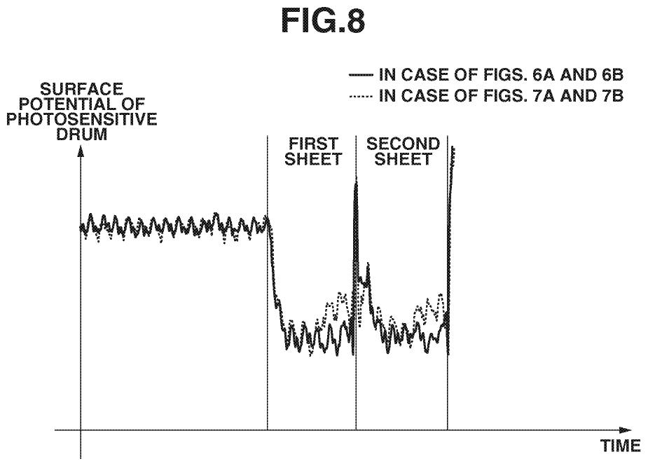

FIG. 8 is a diagram illustrating a result of measurement of the surface potential of the photosensitive drum 1 from a downstream side of the transfer nip portion 11.

FIG. 8 illustrates surface potentials of the photosensitive drum 1 when two sheets of a blank image are printed in the case illustrated in FIGS. 6A and 6B, and in the case illustrated in FIGS. 7A and 7B. A horizontal axis indicates time, and a vertical axis indicates the surface potential of the photosensitive drum 1. In a measurement result chart, a higher position indicates a larger absolute value of the surface potential. A solid line chart indicates a result in the case illustrated in FIGS. 6A and 6B (the loop amount increases). A dotted line chart indicates a result in the case illustrated in FIGS. 7A and 7B (the loop amount decreases). Behaviors of the surface potential on first and second sheets have a common tendency. During a first half period for the first sheet and a first half period for the second sheet, the behavior in the case of FIGS. 6A and 6B is similar to the behavior in the case of FIGS. 7A and 7B. During a last half period for the first sheet and a last half period for the second sheet, the surface potential in the case of FIGS. 7A and 7B increases as compared with the surface potential in the case of FIGS. 6A and 6B. This is because a leading edge of the recording material P reaches the fixing nip portion 12 at timing when a center of the recording material P passes through a vicinity of the transfer nip portion 11. The surface potential changes by the above-described mechanism.

Therefore, in a situation where the recording material P is conveyed with the behavior in the case of FIGS. 7A and 7B (the loop amount decreases), the surface potential of the photosensitive drum 1 is maintained high. Consequently, the image force of paper dust adhering to the surface of the photosensitive drum 1 increases. Since the paper dust reaches the contact portion between the cleaning blade 6 and the photosensitive drum 1 under the condition in which the image force is strong, the condition in this case is disadvantageous for cleaning.

### (Change in Conveyance Speed Due to Pressure Roller Temperature)

Heat generated by the fixing film 7 illustrated in FIG. 1 and the like is used to heat and fix an unfixed image (a toner image) on the recording material P to a surface of the recording material P. However, a flow destination of the heat generated by the fixing film 7 is not limited to this. For example, part of the heat flows into the pressure roller 8 having a comparatively large heat capacity. When the temperature of the pressure roller 8 gradually rises as a printing operation is repeated, the pressure roller 8 thermally expands and an outer diameter of the pressure roller 8 increases. Consequently, the conveyance speed of the recording material P at the fixing nip portion 12 increases as the outer diameter of the pressure roller 8 increases.

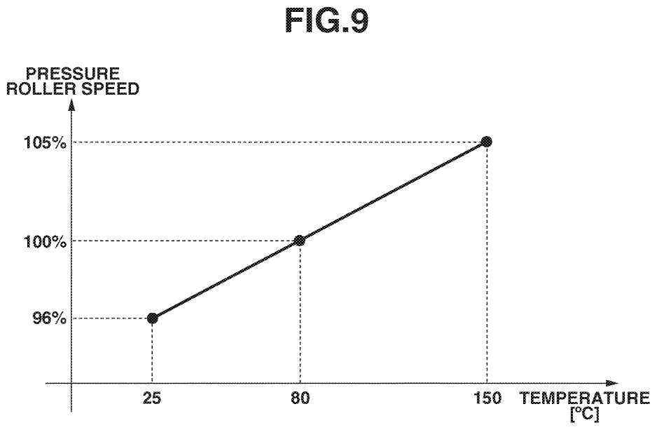

FIG. 9 is a graph illustrating a relation between the speed and the temperature of the pressure roller 8. The relation illustrated in FIG. 9 is calculated based on a thermal expansion rate of the pressure roller 8 according to the present embodiment. A vertical axis indicates the speed of the pressure roller 8, and a horizontal axis indicates the temperature of the pressure roller 8. The speed when, after performing only printing operations on several sheets, the temperature of the pressure roller 8 is around 80 °C and is comparatively low (cold state) is set to 100%. The speed when the temperature of the pressure roller 8 is around 25 °C, which is close to room temperature, and the speed when the temperature of the pressure roller 8 is around 150 °C, which is comparatively high (hot state) are plotted.

The speed of the pressure roller 8 when the temperature of the pressure roller 8 is 25 °C and the speed when the temperature of the pressure roller 8 is 150 °C are represented as change rates relative to the speed when the temperature of the pressure roller 8 is 80 °C.

In the present embodiment, when the speed of the pressure roller 8 exceeds 105%, the recording material P is in an orientation to wind around the photosensitive drum 1, as illustrated in FIGS. 7A and 7B (the loop amount decreases).

### (Method for Predicting Pressure Roller Temperature)

The pressure roller temperature prediction unit B6 will be described below.

A phenomenon in which heat flows into the pressure roller 8 continues until a heat balance is achieved. The heat balance in this case refers to a heat balance between an amount of heat flowing into the pressure roller 8 and an amount of heat radiated from the pressure roller 8. Thus, when the temperature of the pressure roller 8 is relatively low, heat generated by the fixing film 7 tends to flow into the pressure roller 8 more easily than when the temperature of the pressure roller 8 is relatively high. In the present embodiment, the warming state of the pressure roller 8 is defined by focusing on the temperature of the pressure roller 8 as an index indicating how easily heat flows into the pressure roller 8.

The present embodiment adopts, as information about the warming state of the pressure roller 8, a predicted value acquired by the pressure roller temperature prediction unit B6. The predicted value is obtained by using a fixing count prediction method for predicting the warming state of the pressure roller 8.

The predicted value obtained by the fixing count prediction method factors in a power application time for the fixing film 7. When power is supplied to the fixing film 7 for a second power application time longer than a first power application time, a heat quantity generated by the fixing film 7 flows into the pressure roller 8, which further raises the temperature of the pressure roller 8. This enables predicting the temperature of the pressure roller 8 according to the power application time and also predicting a change in the loop amount accompanying a change in the diameter of the pressure roller 8. Accordingly, a toner purge operation according to the loop amount can be achieved.

The fixing count prediction method can improve the prediction accuracy. In this method, a printing operation serving as a heat processing operation is divided into a plurality of phases. For each operation phase, values proportional to a heat quantity applied to the pressure roller 8 per unit time are stored in advance and set as coefficients.

Every time an operation phase lasts for a predetermined period, a value corresponding to the relevant coefficient is added, and the resulting integrating count is determined as information about the warming state. The temperature of the pressure roller 8 is predicted based on the integrating count.

More specifically, a time related to the printing operation is divided into four phases: a pre-heating time, a sheet passing time, a sheet interval time, and a main body deactivation time. The pre-heating time refers to a period from when the fixing film 7 starts to be supplied with power until the recording material P (a first recording material) is guided into the fixing nip portion 12. The sheet passing time refers to a period from when the recording material P is guided into the fixing nip portion 12 until the recording material P is completely discharged from the fixing nip portion 12. The sheet interval time refers to a period from when the recording material P (the first recording material) is discharged from the fixing nip portion 12 until a following recording material P (a second recording material) is guided into the fixing nip portion 12 in continuous sheet passing. The main body deactivation time refers to a period during which no printing operation is performed, excluding the above-described three operation periods. Different coefficients are predetermined for these divided time periods (referred to as operating states or operation phases). These coefficients are proportional to a heat quantity applied to the pressure roller 8 per unit time and are calculated based on differences in supplied power and differences in an amount of heat radiation in each operation phase.

The sheet interval time refers to a period in continuous sheet passing and varies based on the number of continuously fed sheets. More specifically, the sheet interval time may differ between a first continuous sheet passing time and a second continuous sheet passing time that is different from that of the first continuous sheet passing time.

According to the present embodiment, coefficient values are set as illustrated in Table 1. In each operating state (or operation phase), the corresponding coefficient is added each time a unit time has elapsed. The temperature of the pressure roller 8 is predicted according to an integrating count indicating a value integrated by the addition. The unit time is set to 200 msec.

TABLE 1

| | Integrating count | | |
|---|---|---|---|
| Operating state | 0 to 1000 | 1001 to 3000 | 3001 or larger |
| Pre-heating | 7 | 5 | 3 |
| Sheet passing | 5 | 3 | 1 |
| Sheet interval | 3 | 2 | 1 |
| Main body deactivation | −5 | −10 | −20 |

More specifically, the coefficients are stored in a memory (not illustrated). The pressure roller temperature prediction unit B6 reads a relevant coefficient from the memory corresponding to each operation phase. The pressure roller temperature prediction unit B6 adds the relevant coefficient at intervals of the unit time and acquires the integrating count. Each coefficient may be stored in the temperature information storage unit B7.

When power of the main body of the image forming apparatus 100 is turned OFF, the integrating count is reset. However, when power is turned ON, an initial value of the integrating count is determined based on information from the thermistor 62 illustrated in FIG. 2. Subsequently, a relevant coefficient is appropriately added to the initial value every time the unit time has elapsed.

A case in which an environmental detection sensor is used for measuring temperature and humidity of an installation environment in which the image forming apparatus 100 is installed is described. In this configuration, coefficients may be corrected based on acquired temperature and humidity information. In this case, for each environment, the temperature of the recording material P, the amount of heat radiation of the pressure roller 8, the supplied power amount, and the like are taken into consideration as factors affecting the predicted temperature of the pressure roller 8. This correction is intended to improve the prediction accuracy for the actual temperature of the pressure roller 8.

The method for predicting the warming state of the pressure roller 8 is not limited to the above-described method, and a method for determining the warming state based on a print number, which is the number of heat-processed recording materials, is also applicable. For example, in a case where the temperature detected by the thermistor 62 is a predetermined temperature or more when a printing operation is started, the warming state of the pressure roller 8 may be determined to be a high-temperature state (hot state). A temperature detection element for detecting the temperature of the pressure roller 8 may be provided.

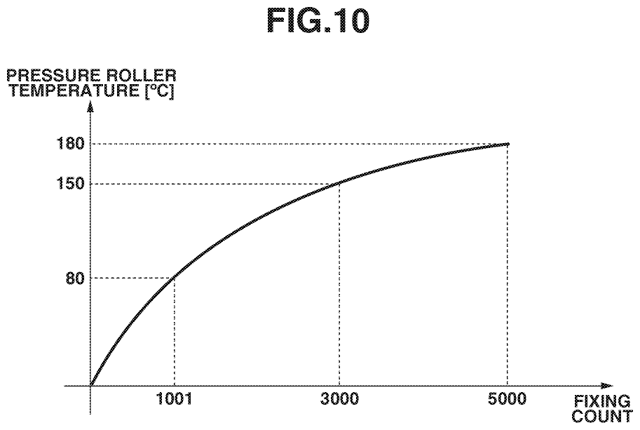

FIG. 10 illustrates a relationship between an integrating count based on the fixing count prediction method and the temperature of the pressure roller 8.

According to this method, the fixing count is smaller as the pressure roller 8 is colder. For example, when the temperature of the pressure roller 8 is around 80 °C, which corresponds to the cold state, the fixing count is around 1,001. When the temperature of the pressure roller 8 is around 150 °C, which corresponds to the hot state, the fixing count is around 3,000.

More specifically, when a second integrating count (second fixing count) is larger than a first integrating count (first fixing count) based on the fixing count prediction method, the temperature of the pressure roller 8 corresponding to the second integrating count is predicted to be higher.

The fixing count prediction method is used mainly in a configuration in which, as in the present embodiment, driving of the fixing apparatus 80 and driving of conveyance of the recording material P are generated by the same single driving source. This is because the conveyance state of the recording material P is synchronized with an operation of the fixing apparatus 80, and thus a loop amount of the recording material P can be predicted based on a temperature state of the pressure roller 8. Accordingly, the number of sensor components can be reduced to achieve cost reduction and a simplified configuration.

### Toner Purge Sequence According to First Embodiment

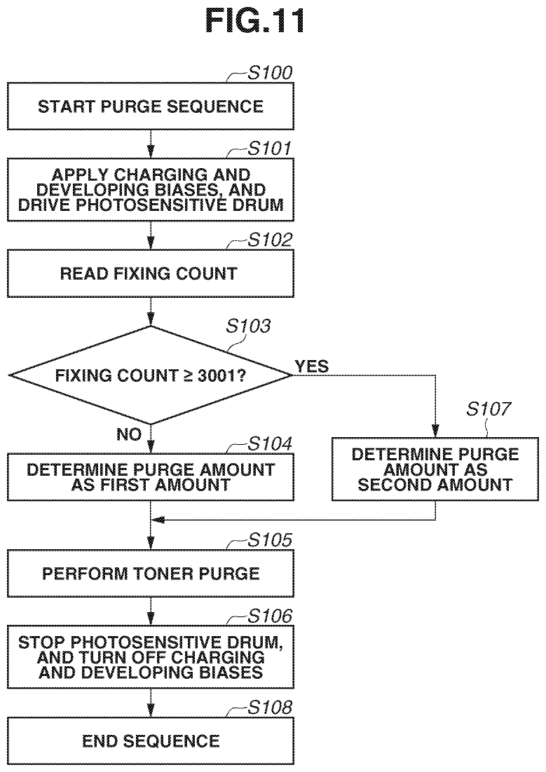

FIG. 11 illustrates a flowchart according to the first embodiment. The flowchart indicates processing until the amount of toner purge is determined.

Operations of the steps will be described below with reference to the flowchart. In the present embodiment, the toner purge sequence is performed at the above-described post-rotation timing.

In step S100, the toner purge sequence is started. In step S101, a bias equivalent to that at an image forming time is applied to the charging roller 2 and the developing roller 25, and the photosensitive drum 1 is driven. In step S102, the fixing count is read out to determine the amount of toner purge. In step S103, the central processing unit B1 illustrated in FIG. 4 determines whether the fixing count is 3,001 or more.

In a case where the fixing count is less than 3,001 (NO in step S103), the processing proceeds to step S104. In step S104, it is determined that the amount of toner purge is a first amount (first toner amount). A toner image is formed on the photosensitive drum 1 such that the amount of toner purge becomes the first amount, and in step S105, a toner purge operation is performed. After completion of the toner purge operation, driving of the photosensitive drum 1 is stopped. In step S106, the bias applied to the charging roller 2 and the developing roller 25 is turned off. In step S108, the sequence ends.

In a case where the fixing count is 3,001 or more (YES in step S103), the fixing count indicates that the pressure roller 8 is in the hot state. In this case, adhesion of paper dust to the photosensitive drum 1 increases by the above-described mechanism. In step S107, it is determined that the amount of toner purge is to be a second amount (second toner amount) larger than the first amount. A toner image is formed on the photosensitive drum 1 such that the amount of toner purge becomes the second amount, and in step S105, a toner purge operation is performed.

After completion of the toner purge operation, operations similar to the above-described operations are performed.

To control the amount of toner purge, a toner image width in a circumferential direction of the photosensitive drum 1 may be changed by changing an exposure time. Alternatively, if possible, an intensity of a laser for exposure may be changed to control the amount of toner deposited per unit area of the photosensitive drum 1.

### First Evaluation Experiment

To indicate effects of the present embodiment, a result of an experimental comparison with comparative examples will be described below. In the experiment, 30K sheets were fed in an intermittent operation under environmental conditions of 15 °C temperature and 10% humidity. In the intermittent operation, each time two sheets having an image with a 2% image printing ratio were printed, the printing operation was suspended for 3 seconds. 30K sheets means 30,000 sheets, and hereinafter 1,000 sheets are referred to as 1K sheets. Subsequently, cleaning performance was ranked for samples output as a halftone image with a 25% printing ratio. Canon® Red Label paper was used as the recording material P.

In the “Cleaning result” row indicating the experimental result in Table 2, “o” indicates that no vertical streak occurs, and “x” indicates that a vertical streak occurs. The “Void image number” row indicates the number of sheets printed until a void image (a blank area with no toner printed on a printed recording material) occurred after sheet passing was performed until toner in a toner container ran out.

In the experiment, conditions of the amount of toner purge were changed in three configurations: a first comparative example, a second comparative example, and a first example according to the present embodiment, and the cleaning result and the void image number were compared, and an evaluation among these configurations was performed.

The condition of the first comparative example is that the amount of toner purge is 10 mg for each intermittent operation. The condition of the second comparative example is that the amount of toner purge is 20 mg. The condition of the first example is that the amount of toner purge is 10 mg when the fixing count is less than 3,001, and 20 mg when the fixing count is 3,001 or more. Table 2 illustrates the configurations of the first comparative example, the second comparative example, and the first example according to the present embodiment, and experimental results for these configurations.

TABLE 2

| | | | Second | |
|---|---|---|---|---|
| | | First comparative | comparative | First |
| | | example | example | example |
| Amount of | Fixing | 10 mg | 20 mg | 10 mg |
| toner purge | count ≤ 3000 | | | |
| | Fixing | 10 mg | 20 mg | 20 mg |
| | count > 3000 | | | |

| | | | |
|---|---|---|---|
| Cleaning result | x | ∘ | ∘ |
| Void image number | 45K | 36K | 40K |

In the first comparative example, the toner purge amount was 10 mg, which was not sufficient for re-forming the lubrication layer 6a. Since the lubrication layer 6a was not completely re-formed, paper dust passed through the lubrication layer 6a, which caused a problem in cleaning performance at 30K sheet passing. Meanwhile, the void image number was 45K.

In the second comparative example, the toner purge amount was 20 mg, which was twice the toner purge amount of the first comparative example and was sufficient for re-forming the lubrication layer 6a. Although there was no problem with the cleaning result at 30K sheet passing, the void image number was 36K, which was a remarkable decrease as compared with the first comparative example.

In the first example, the toner purge amount when the fixing count was 3,001 or more was set to 20 mg, which was equivalent to the toner purge amount of the second comparative example. Under this condition, the pressure roller 8 was in the hot state, and adhesion of paper dust to the photosensitive drum 1 was high. At this time, the toner amount was sufficient for re-forming the lubrication layer 6a, and there was no problem with the cleaning result at 30K sheet passing.

Further, in the first example, the toner purge amount when the fixing count was less than 3,001 was set to 10 mg, which was half the toner purge amount of the second comparative example. This was a condition for the state in which the pressure roller 8 was not in the hot state, and adhesion of paper dust to the photosensitive drum 1 was not high. Consequently, the void image number, that is, the number of sheets at which a void image occurred, increased to 40K.

As described above, the image forming apparatus according to the first embodiment used the fixing count as a temperature prediction unit for the pressure roller 8 and changed a toner purge condition according to the fixing count.

In the present embodiment, the fixing count reflecting the power application time for the heater 60 is used as the temperature prediction unit for the pressure roller 8. However, the temperature prediction unit is not limited to this as long as the temperature prediction unit can obtain the temperature of the pressure roller 8 by measurement or prediction. For example, a temperature detection element may be provided for the pressure roller 8. Alternatively, an estimation unit for estimating the temperature of the pressure roller 8 by using the temperature of the heater 60 detected by the thermistor 62 and a heat transfer equation may be provided. Further alternatively, a machine learning model or a statistical method may be used.

In the present embodiment, the fixing apparatus 80 heats the fixing film 7 by using a ceramic heater. However, application of the present disclosure is not limited to this configuration. Similar effects can be obtained with a configuration in which a degree of winding of the recording material P around the photosensitive drum 1 changes due to thermal expansion of the pressure roller 8. For example, a radiation film heating method using a halogen heater or the like may be used for the fixing apparatus 80. Alternatively, a film heating method based on induction heating using a heating member including a magnetic core and an excitation coil may be used for the fixing apparatus 80. The present disclosure is applicable to various types of image heating apparatuses including the fixing film 7 to be heated and the pressure roller 8 that forms a nip portion with the fixing film 7.

Effects specific to the present disclosure include maintaining cleaning performance without consuming toner more than necessary, as described above. Another effect is increasing the printable sheet number by not consuming toner more than necessary. Still another effect is implementing both cleaning performance and the printable sheet number with a simple configuration without requiring a special configuration.

In the present embodiment, at the transfer nip portion 11 and the fixing nip portion 12, all members are driven only by the main motor 50. In a case of a configuration with another driving source, the degree of winding can be controlled by using another driving source. However, when the members are driven only by the main motor 50, the degree of winding cannot be controlled by accelerating or decelerating transfer relative to fixing. As described above, the present disclosure is particularly effective in driving the transfer nip portion 11 and the fixing nip portion 12 by using the main motor 50. This is because use of the present disclosure eliminates a need to use any driving source other than the main motor 50 for controlling the degree of winding. As described above, both cleaning performance and the printable sheet number can be achieved with a simple configuration without requiring an additional driving source.

### Second Embodiment

A second embodiment of the present disclosure will be described below. In the present embodiment, a drive configuration includes a fixing motor 51 for driving a fixing apparatus 80 and a main motor for driving other members. A fixing count is not used as a condition for changing the amount of toner purge. In the present embodiment, since a driving source for the fixing apparatus 80 is different from a driving source for conveyance of a recording material P, it is difficult to predict a loop amount of the recording material P based on a temperature of a pressure roller 8. Therefore, the amount of toner purge is changed according to a warp amount of paper detected by a loop sensor. For configurations similar to the configurations of the first embodiment, illustrations are omitted, or the same reference numerals are assigned, and the redundant descriptions are omitted.

### (Loop Detection Sensor)

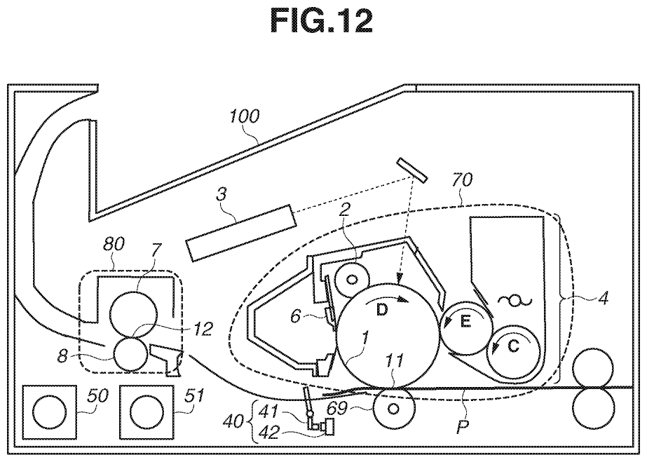

FIG. 12 is a schematic cross-sectional view illustrating an image forming apparatus according to the second embodiment. A detection flag 41 is provided on a conveyance guide between a transfer nip portion 11 and a fixing nip portion 12. The detection flag 41 detects a loop amount of the recording material P. The detection flag 41 is a bar-like member swingable about the one end. The other end of the detection flag 41 is disposed to project from a conveyance surface of the conveyance guide toward a conveyance path. The detection flag 41 is biased in one direction by a spring member (a biasing member, not illustrated) and is pushed to swing by a loop formed in the recording material P. When the detection flag 41 is pushed, the detection flag 41 swings in a swing direction in which the detection flag 41 is retracted from the conveyance path. An amount of swing changes according to the loop amount. A flag extending downward below the conveyance surface is provided at one end of the detection flag 41 (a swing center of the detection flag 41). The flag is configured to move in association with swinging of the detection flag 41 to open or block an optical path of a photo-interrupter 42. The photo-interrupter 42 includes a light emitting unit and a light receiving unit and outputs an ON signal when the optical path from the light emitting unit to the light receiving unit is blocked. Based on an open or blocked state of the optical path, it is detected whether the loop amount of the recording material P exceeds a predetermined value. That is, the photo-interrupter 42 is turned on or off in association with the swinging motion of the detection flag 41. The photo-interrupter 42 and the detection flag 41 operate in cooperation to configure a loop detection sensor 40 (flag sensor).

When an output value of the loop detection sensor 40 is ON, the output value indicates a loop amount larger than the predetermined value and a small degree of winding of the recording material P around the photosensitive drum 1. When the output value of the loop detection sensor 40 is OFF, the output value indicates a loop amount less than the predetermined value and a large degree of winding of the recording material P around the photosensitive drum 1.

### Toner Purge Sequence According to Second Embodiment

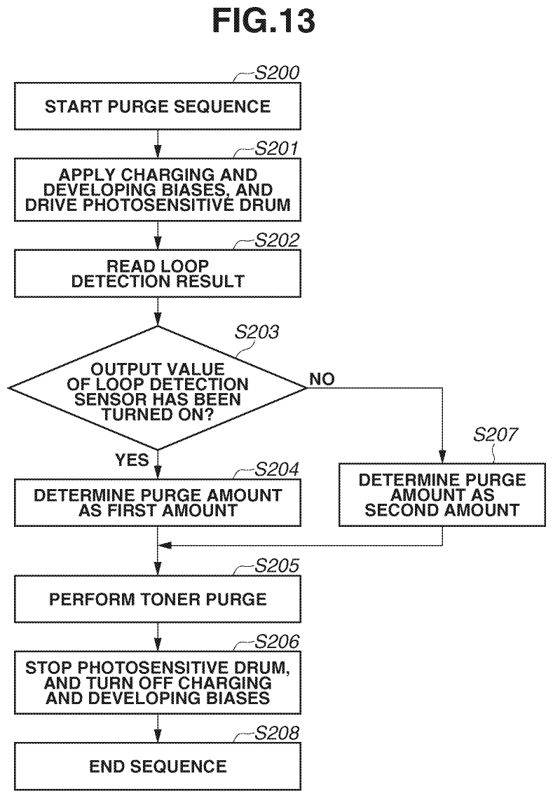

FIG. 13 is a flowchart illustrating processing for determining the amount of toner purge according to the second embodiment.

Operations of the steps of the flowchart will be described below.

In step S200, a toner purge sequence is started. In step S201, a bias equivalent to a bias at an image forming time is applied to the charging roller 2 and the developing roller 25, and the photosensitive drum 1 is driven. In step S202, a detection result is read out from a storage unit storing an output of the loop detection sensor to determine the amount of toner purge.

A detection result indicating whether the loop detection sensor 40 has been turned on during execution of a print job is stored in a storage unit (not illustrated). In step S203, based on the detection result that has been stored in and read out from the storage unit, it is determined whether the output value of the loop detection sensor 40 has been turned ON or has been kept OFF throughout the print job.

In a case where the output value of the loop detection sensor 40 has been turned ON during execution of a first print job, the detection result indicates that there has been a timing when the loop amount has been large. After completion of the first print job, it is determined that a degree of winding of the recording material P around the photosensitive drum 1 during execution of the print job has been small. In step S204, it is determined that the amount of toner purge is to be the first amount.

In step S205, a toner image is formed on the photosensitive drum 1 in such a manner that the amount of toner purge becomes the first amount, and a toner purge operation is performed. After completion of the toner purge operation, driving of the photosensitive drum 1 is stopped. In step S206, the bias applied to the charging roller 2 and the developing roller 25 is turned off. In step S208, the sequence ends.

In a case where the output value of the loop detection sensor 40 has been OFF throughout a second print job, the detection result indicates that the loop amount has been relatively small throughout the second print job. More specifically, after completion of the second print job, it is determined that a degree of winding of the recording material P around the photosensitive drum 1 has been large during execution of the print job. In this case, adhesion of paper dust to the photosensitive drum 1 increases by the above-described mechanism. Therefore, in step S207, it is determined that the amount of toner purge is to be the second amount larger than the first amount. In step S205, a toner image is formed on the photosensitive drum 1 in such a manner that the amount of toner purge becomes the second amount, and a toner purge operation is performed. Operations after the toner purge operation are similar to the above-described operations.

Information about the storage unit for storing the detection result of the loop detection sensor is reset and updated for each sheet passing. (Second Evaluation Experiment)

To indicate effects of the present embodiment, a result of an experimental comparison with comparative examples will be described below. In evaluation of this experiment, evaluation was performed in a manner similar to the first evaluation experiment in the first embodiment.

In this experiment, conditions of the amount of toner purge were changed in three configurations: a third comparative example, a fourth comparative example, and a second example according to the present embodiment, and a cleaning result and a void image number were compared, and an evaluation among these configurations was performed.

A condition of the third comparative example is that the amount of toner purge is 10 mg for each intermittent operation. A condition of the fourth comparative example is that the amount of toner purge is 20 mg. A condition of the second example is that the amount of toner purge is 10 mg when the output value of the loop detection sensor 40 is on and 20 mg when the output value of the loop detection sensor 40 is OFF. Table 3 illustrates experimental results for configurations of the third comparative example, the fourth comparative example, and the second example.

TABLE 3

| | | | Fourth | |
|---|---|---|---|---|
| | | Third comparative | comparative | Second |
| | | example | example | example |
| Output value of loop | ON | 10 mg | 20 mg | 10 mg |
| detection sensor | OFF | 10 mg | 20 mg | 20 mg |

| | | | |
|---|---|---|---|
| Cleaning result | x | ∘ | ∘ |
| Void image number | 45K | 36K | 40K |

In the third comparative example, the toner purge amount was 10 mg, which was not sufficient for re-forming the lubrication layer 6a. Since the lubrication layer 6a was not completely re-formed, paper dust passed through the lubrication layer 6a, which caused a problem in cleaning performance at 30K sheet passing. Meanwhile, the void image number was 45K.

In the fourth comparative example, the toner purge amount was 20 mg, which was twice the toner purge amount of the third comparative example, so that the amount was sufficient for re-forming the lubrication layer 6a. Thus, there was no problem with the cleaning result at 30K sheet passing, but the void image number was 36K, which was a remarkable decrease as compared with the third comparative example.

In the second example, the toner purge amount when the output value of the loop detection sensor 40 was ON is set to 10 mg, which is equivalent to the toner purge amount of the third comparative example. When the output value of the loop detection sensor 40 was ON, the loop amount increased, a degree of winding of the recording material P around the photosensitive drum 1 decreased, and adhesion of paper dust to the photosensitive drum 1 was not high. The toner purge amount of 10 mg was sufficient for re-forming the lubrication layer 6a, and there was no problem with the cleaning result at 30K sheet passing.

Further, by setting the toner purge amount when the output value of the loop detection sensor 40 was OFF to 20 mg, which was half the toner purge amount of the fourth comparative example, the void image number increased to 40K. When the output value of the loop detection sensor 40 was OFF, the loop amount is small, a degree of winding of the recording material P around the photosensitive drum 1 is large, and adhesion of paper dust to the photosensitive drum 1 is high.

As described above, as in the image forming apparatus according to the second embodiment, changing a toner purge condition according to an output result of the loop detection sensor 40 can also increase the printable sheet number while maintaining cleaning performance.

Although the present embodiment uses two different motors, the number of motors is not limited to this. For example, driving for the fixing apparatus 80, driving for the photosensitive drum 1, driving for the development apparatus 4, and driving for conveyance of the recording material P may be generated by different driving sources. The present embodiment is applicable in a case where a driving source for the fixing apparatus 80 and a driving source for conveyance of the recording material P are independent of each other.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-074590, filed Apr. 28, 2025, and No. 2025-165228, filed Oct. 1, 2025, which are hereby incorporated by reference herein in their entirety.

What is claimed is:

1. An image forming apparatus comprising:
a photosensitive drum configured to carry a toner image;
a development unit configured to supply toner to a surface of the photosensitive drum to develop the toner image;
a transfer roller configured to come into contact with the photosensitive drum to form a transfer nip portion for transferring the toner image onto a recording material, and convey the recording material;
a cleaning blade configured to come into contact with the photosensitive drum and, after the toner image is transferred onto the recording material, clean the surface of the photosensitive drum;
a heating unit configured to heat the toner image transferred onto the recording material;
a pressure roller configured to come into pressure contact with the heating unit to form a fixing nip portion, and pinch and convey the recording material; and
a loop detection sensor configured to output an ON signal when a loop amount is larger than a predetermined value, the loop amount being a size of a warp of the recording material formed in a state where both the transfer nip portion and the fixing nip portion pinch and convey the recording material,
wherein a second toner amount is larger than a first toner amount, the first toner amount being a toner amount to be supplied, in a case where the ON signal is output from the loop detection sensor during execution of a first print job, to the photosensitive drum at a post-rotation time after completion of the first print job, the second toner amount being a toner amount to be supplied, in a case where the ON signal is not output from the loop detection sensor during execution of a second print job, to the photosensitive drum at the post-rotation time after completion of the second print job.

2. The image forming apparatus according to claim 1, further comprising:
a power source configured to apply a voltage to the transfer roller,
wherein the voltage applied to the transfer roller at the post-rotation time is closer to a surface potential of the photosensitive drum than a voltage applied to the transfer roller at an image forming time, and toner supplied to the surface of the photosensitive drum is not transferred but reaches the cleaning blade to form a lubrication layer at the post-rotation time.

3. The image forming apparatus according to claim 1,
wherein the loop detection sensor includes:
a detection flag disposed to project toward a conveyance path for the recording material and configured to swing in such a manner that one end of the detection flag is retracted from the conveyance path by the swinging;
a biasing member configured to bias the detection flag in one direction in a swinging direction; and
a photo-interrupter including a light emitting unit and a light receiving unit, and configured to output the ON signal in a case where an optical path from the light emitting unit to the light receiving unit is blocked,
wherein, in a case where the recording material comes into contact with the detection flag, the one end of the detection flag swings in a direction of retraction from the conveyance path, and, in association with the swinging of the one end in the direction of retraction, the other end of the detection flag swings to block the optical path of the photo-interrupter.

4. An image forming apparatus comprising:
a photosensitive drum configured to carry a toner image;
a development unit configured to supply toner to a surface of the photosensitive drum to develop the toner image;
a transfer roller configured to come into contact with the photosensitive drum to form a transfer nip portion for transferring the toner image onto a recording material, and pinch and convey the recording material;
a cleaning blade configured to come into contact with the photosensitive drum and, after the toner image is transferred onto the recording material, clean the surface of the photosensitive drum;
a heating unit configured to heat the toner image transferred onto the recording material;
a control unit configured to control the heating unit;
a pressure roller configured to come into pressure contact with the heating unit to form a fixing nip portion, and pinch and convey the recording material; and
a temperature prediction unit configured to predict a temperature of the pressure roller,
wherein a second toner amount is larger than a first toner amount when a second fixing count is larger than a first fixing count, the first fixing count and the second fixing count being fixing counts counted by the temperature prediction unit, the first toner amount being a toner amount to be supplied to the photosensitive drum at a non-image forming time when a value of the fixing count that changes with a power application time for the heating unit is the first fixing count, the second toner amount being a toner amount to be supplied to the photosensitive drum at the non-image forming time when the value of the fixing count is the second fixing count.

5. The image forming apparatus according to claim 4,
wherein an image forming operation time includes a pre-heating time, a sheet passing time, and a sheet interval time,
wherein the pre-heating time is a time period from when power application to the heating unit is started until a first recording material reaches the fixing nip portion,
wherein the sheet passing time is a time period from when the first recording material reaches the fixing nip portion until discharging of the first recording material from the fixing nip portion is completed,
wherein the sheet interval time is a time period from when discharging of the first recording material from the fixing nip portion is completed until a second recording material continuously fed reaches the fixing nip portion,
wherein each fixing count is an integrating count acquired by adding a coefficient per unit time for the pre-heating time, the sheet passing time, the sheet interval time, and a main body deactivation time, at intervals of a predetermined time,
wherein the first fixing count is an integrating count acquired by the temperature prediction unit at the post-rotation time after completion of a first print job, and
wherein the second fixing count is an integrating count acquired by the temperature prediction unit at the post-rotation time after completion of a second print job.

6. The image forming apparatus according to claim 5, wherein the integrating count is reset when power of the image forming apparatus is turned off.
